(19) United States
(12) Patent Application Publication
(10) Pub. No.: US 2026/0292840 A1
(43) Pub. Date: Sep. 24, 2026

(54) METHOD, USER EQUIPMENT, AND BASE STATION FOR A SUBBAND NON-OVERLAPPING FULL DUPLEX OPERATION

(71) Applicant: SHARP KABUSHIKI KAISHA, Sakai City, Osaka (JP)

(72) Inventor: HAI-HAN WANG, Taipei (TW)

(21) Appl. No.: 19/471,994

(22) PCT Filed: Apr. 3, 2024
(86) PCT No.: PCT/CN2024/085981

§ 371 Date: Oct. 2, 2025

Related U.S. Application Data
(60) Provisional application No. 63/457,442, filed on Apr. 6, 2023.

(51) Int. Cl. H04W 72/232; H04L 5/14; H04W 72/21

(52) U.S. Cl. CPC H04W 72/232; H04L 5/14; H04W 72/21

(57) ABSTRACT

A method performed by a UE for a subband non-overlapping full duplex (SBFD) operation is provided. The method includes receiving a first radio resource control (RRC) configuration configuring one or more slot formats for non-SBFD and a second RRC configuration configuring one or more slot formats for SBFD; receiving a downlink control information (DCI) format including one or more slot format indicator (SFI) indexes to indicate one of the one or more slot formats for the non-SBFD and indicate at least one of the one or more slot formats for the SBFD; and performing an uplink (UL) transmission or a downlink (DL) reception based on the indicated one of the one or more slot formats for the non-SBFD and the indicated at least one of the one or more slot formats for the SBFD.

### CROSS-REFERENCE TO RELATED APPLICATION(S)

The present disclosure claims the benefit of and priority to U.S. Provisional Patent Application Ser. No. 63/457,442, filed on Apr. 6, 2023, entitled “SUBBAND NON-OVERLAPPING FULL DUPLEX,” the content of which is hereby incorporated herein fully by reference into the present disclosure for all purposes.

### FIELD

The present disclosure is related to wireless communication and, more specifically, to a method, a user equipment (UE), and a base station (BS) for a subband non-overlapping full duplex (SBFD) operation in cellular wireless communication networks.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there is a need for further improvements in wireless communication in the next-generation wireless communication systems.

### SUMMARY

The present disclosure is related to a method, a user equipment (UE), and a base station (BS) for a subband non-overlapping full duplex (SBFD) operation in cellular wireless communication networks.

In a first aspect of the present application, a method performed by a UE for a subband non-overlapping full duplex (SBFD) operation is provided. The method includes receiving a first radio resource control (RRC) configuration configuring one or more slot formats for non-SBFD and a second RRC configuration configuring one or more slot formats for SBFD; receiving a downlink control information (DCI) format including one or more slot format indicator (SFI) indexes to indicate one of the one or more slot formats for the non-SBFD and indicate at least one of the one or more slot formats for the SBFD; and performing an uplink (UL) transmission or a downlink (DL) reception based on the indicated one of the one or more slot formats for the non-SBFD and the indicated at least one of the one or more slot formats for the SBFD.

In an implementation of the first aspect, the DL reception includes a physical downlink control channel (PDCCH) reception, a physical downlink shared channel (PDSCH) reception, or a DL reference signal reception.

In another implementation of the first aspect, the UL transmission includes a physical uplink control channel (PUCCH) transmission, a physical uplink shared channel (PUSCH) transmission, or a sounding reference signal (SRS) transmission.

In another implementation of the first aspect, in a case that the UL transmission includes the PUCCH transmission and the PUCCH transmission is performed in non-SBFD symbols indicated by the indicated one of the one or more slot formats for the non-SBFD, the PUCCH transmission is associated with a first PUCCH configuration, and in a case that the UL transmission includes the PUCCH transmission and the PUCCH transmission is performed in SBFD symbols indicated by the indicated at least one of the one or more slot formats for the SBFD, the PUCCH transmission is associated with a second PUCCH configuration.

In another implementation of the first aspect, in a case that the UL transmission includes the PUCCH transmission and the PUCCH transmission is performed in both the SBFD symbols and the non-SBFD symbols, the PUCCH transmission is associated with the second PUCCH configuration.

In another implementation of the first aspect, a first slot format of the one or more slot formats for the SBFD corresponds to a first subband, and a second slot format of the one or more slot formats for the SBFD corresponds to a second subband.

In a second aspect of the present application, a UE for a subband non-overlapping full duplex (SBFD) operation is provided. The UE includes one or more processors; and at least one memory coupled to the one or more processors, the at least one memory storing computer-executable instructions that, when executed by the one or more processors, cause the UE to receive a first radio resource control (RRC) configuration configuring one or more slot formats for non-SBFD and a second RRC configuration configuring one or more slot formats for SBFD; receive a downlink control information (DCI) format including one or more slot format indicator (SFI) indexes to indicate one of the one or more slot formats for the non-SBFD and indicate at least one of the one or more slot formats for the SBFD; and perform an uplink (UL) transmission or a downlink (DL) reception based on the indicated one of one or more slot formats for the non-SBFD and the indicated at least one of the one or more slot formats for the SBFD.

In a third aspect of the present application, a BS for a subband non-overlapping full duplex (SBFD) operation is provided. The BS includes one or more processors; and at least one memory coupled to the one or more processors, the at least one memory storing computer-executable instructions that, when executed by the one or more processors, cause the BS to transmit a first radio resource control (RRC) configuration configuring one or more slot formats for non-SBFD and a second RRC configuration configuring one or more slot formats for SBFD; transmit downlink control information (DCI) format including one or more slot format indicator (SFI) indexes to indicate one of the one or more slot formats for the non-SBFD and indicate at least one of the one or more slot formats for the SBFD; and perform an uplink (UL) reception or a downlink (DL) transmission based on the indicated one of the one or more slot formats for the non-SBFD and the indicated at least one of the one or more slot formats for the SBFD.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating a slot format pattern for non-SBFD, according to an example implementation of the present disclosure.

FIG. 2 is a schematic diagram illustrating a slot format pattern for SBFD and non-SBFD, according to an example implementation of the present disclosure.

FIG. 3 is a schematic diagram illustrating different N_{TA,offset} for non-SBFD and SBFD symbols, according to an example implementation of the present disclosure.

FIG. 4 is a schematic diagram illustrating configured DL receptions in DL subbands, according to an example implementation of the present disclosure.

FIG. 5 is a schematic diagram illustrating that semi-static SBFD symbols are converted to DL symbols, according to an example implementation of the present disclosure.

FIG. 6 is a flowchart illustrating a method performed by a UE for an SBFD operation, according to an example implementation of the present disclosure.

FIG. 7 is a flowchart illustrating a method performed by a BS for an SBFD operation, according to an example implementation of the present disclosure.

FIG. 8 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AI | Aggregation level |
| BFD | Beam Failure Detection |
| BWP | Bandwidth Part |
| CA | Carrier Aggregation |
| CORESET | Control Resource Set |
| CC | Component Carrier |
| CCE | Control Chanel Element |
| CJT | Coherent Joint Transmission |
| CRC | Cyclic Redundancy Check |
| C-RNTI | Cell-Radio Network Temporary Identifier |
| CS-RNTI | Configured Scheduling-Radio Network |
| | Temporary Identifier |
| CSS | Common Search Space |
| CSI | Channel State Information |
| DC | Dual Connectivity |
| DCI | Downlink Control Information |
| DL | Downlink |
| FDM | Frequency Division Multiplexing |
| GC-PDCCH | Group Common-Physical Downlink Control Channel |
| HARQ | Hybrid Automatic Repeat Request |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| MAC | Medium Access Control |
| MAC CE | MAC Control Element |
| MCG | Master Cell Group |
| MCS-C-RNTI | Modulation Coding Scheme-Cell-Radio |
| | Network Temporary Identifier |
| MIB | Master Information Block |
| mTRP | Multiple Transmission Reception Point |
| MIMO | Multiple-input Multiple-output |
| MSB | Most Significant Bit |
| NACK | Negative Acknowledgment |
| NDI | New Data Indicator |
| NR | New RAT/Radio |
| NW | Network |
| PCI | Physical Cell ID |
| PCell | Primary Cell |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| PHY | Physical (layer) |
| PRACH | Physical Random Access Channel |
| PTAG | Primary Timing Advance Group |
| PUCCH | Physical Uplink Control Channel |
| PUSCH | Physical Uplink Shared Channel |
| RA | Random Access |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RRM | Radio Resource Management |
| RS | Reference Signal |
| RSRP | Reference Signal Received Power |
| RV | Redundancy Version |
| SCell | Secondary Cell |
| SCG | Secondary Cell Group |
| SCS | Subcarrier Spacing |
| SDM | Spatial Division Multiplexing |
| SFI | Slot Format Indicator |
| SFN | Single Frequency Network |
| SINR | Signal to Interference plus Noise Ratio |
| SpCell | Special Cell |
| SR | Scheduling Request |
| SRI | SRS resource indicator |
| SRS | Sounding Reference Signal |
| SSB | Synchronization Signal Block |
| STAG | Secondary Timing Advance Group |
| STxMP | Simultaneous Transmission on Multiple Panels |
| SUL | Supplementary UL |
| TA | Timing Advance |
| TAG | Timing Advance Group |
| TB | Transport Block |
| TBS | Transport Block |
| TCI | Transmission Configuration Indication |
| TDM | Time Division Multiplexing |
| TPMI | Transmission Precoding Matrix Indicator |
| TR | Technical Report |
| TRP | Transmission Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WG | Working Group |
| WI | Working Item |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Examples of some selected terms in the present disclosure are provided as follows.

BWP: A subset of the total cell bandwidth of a cell may be referred to as a bandwidth part (BWP), and beamwidth adaptation may be achieved by configuring the UE with one or more BWPs and informing the UE which of the configured BWPs is currently active. To enable bandwidth adaptation (BA) on the PCell, the gNB may configure the UE with both UL and DL BWPs. To enable BA on SCells in the case of carrier aggregation (CA), the gNB may configure the UE with at least DL BWP(s) (e.g., there may be none in the UL). For the PCell, the initial BWP may be the BWP used for an initial access. For the SCell(s), the initial BWP may be the BWP configured for the UE to first operate upon an SCell activation. The UE may be configured with a first active uplink BWP by an information element (IE), such as a firstActiveUplinkBWP IE. If the first active uplink BWP is configured for an SpCell, the firstActiveUplinkBWP IE field may include the ID of the UL BWP to be activated upon performing the RRC (re-)configuration. If such IE field is absent, the RRC (re-)configuration may not impose a BWP switch. If the first active uplink BWP is configured for an SCell, the firstActiveUplinkBWP IE field may include the ID of the uplink bandwidth part to be used upon a MAC activation of an SCell.

The TDD may be extensively used in NR deployments. The TDD may divide the time domain between downlink and uplink. Allocating limited time for uplink in TDD may lead to reduced coverage, increased latency, and lower capacity. To overcome these limitations, it may be worthwhile to explore the feasibility of full duplex operation, allowing downlink and uplink to coexist simultaneously. Specifically, investigating subband non-overlapping full duplex at the gNB side within a conventional TDD band may offer significant enhancements.

The NR TDD specifications may facilitate dynamic and flexible allocation of downlink and uplink, along with cross-link interference (CLI) handling and remote interference management (RIM), introduced in Rel-16. However, further investigation may be necessary for managing CLI between gNBs belonging to either the same or different operators to enable dynamic and flexible TDD operations in commercial networks. The inter-gNB CLI may stem from adjacent-channel CLI, co-channel CLI, or both, varying by the deployment scenario. An unresolved issue from previous releases may be the gNB-to-gNB CLI.

A synchronization signal block (SSB) may be used by a UE for a DL synchronization and a measurement of the signal strength of a cell. Multiple SSBs may be transmitted by a gNB and each SSB may be transmitted via different beams. A SSB may carry MIB which includes a configuration of the CORESET 0 and the search space 0 that are used for scheduling the SIB1. The SIB1 may carry the configurations related to the cell selection and the initial access (e.g., the PRACH resource configuration). The UE may evaluate the measured results based on the configurations in the SIB1 to determine whether to camp on the cell and perform the initial access. During the initial access, the initial DL BWP may be defined as the PRBs including the CORESET 0. The initial DL BWP may be used for receiving the RACH procedure related DL messages (e.g., the random access response (RAR), the Message 4 (Msg4), and other messages) before the dedicated DL BWP is configured by the gNB. The initial DL BWP may also be used for receiving the system information and the paging messages.

A Type-1 common search space may be configured by the SIB1 to be associated with the CORESET 0 or a CORESET configured by the commonControlResourceSet for receiving the DCI that schedules the RAR, the Msg4, and other messages before the dedicated DL BWP is configured by the gNB. A Type-2 common search space may be configured by the SIB1 to be associated with the CORESET 0 or a CORESET configured by the commonControlResourceSet for receiving the DCI that schedules the paging messages. After initial access, the initial DL BWP may be defined as the PRBs configured by the initial DL BWP configuration carried in the SIB1, if configured. Otherwise, the initial DL BWP may be the same as that used during the initial access. On the other hand, during and after the initial access, the initial UL BWP may be defined as the PRBs configured by the initial UL BWP configuration carried in the SIB1.

In Rel-15, the PRACH resources for the initial access may be configured by the SIB1. Specifically, the initial UL BWP configuration provided by the SIB1 may include the BWP-UplinkCommon which includes the RACH-ConfigCommon that is used to configure the PRACH resources. For the RRC connected UEs, the PRACH resources may also be configured in other UL BWPs, and the UE may use the PRACH resources when the UL BWP with the PRACH resources is the active UL BWP.

In NR, the DCI may be transmitted by a gNB to a UE via the PDCCH using one or more control channel elements (CCEs) included in a CORESET. The configurations of a CORESET may include the configuration of the PRBs of which the frequency domain resource is used for the CORESET and include the configuration of the number of OFDM symbols that defines the time duration of the CORESET. One or more search spaces may be associated with a CORESET. A search space may define the occasions of the associated CORESET, and one occasion of the CORESET may include a monitoring occasion. The configurations of a search space may include configuration of the periodicity and time offset of the search space and configuration of the duration of the search space (e.g., the consecutive number of slots in which one or more monitoring occasions exist). If duration is configured as one, there may be only one slot in which monitoring occasion(s) exist in each period. The configurations of a search space may also include the configuration of the type of the search space (e.g., the UE-specific search space (USS) or the common search space (CSS)), and the DCI format(s) that are monitored in the search space. The configurations of a search space may also include the configuration of the number of PDCCH candidates per aggregation level (AL). It may be noted that a search space may also be referred as a search space set. After being configured with the CORESETs and the search spaces, the UE may attempt to decode the PDCCH candidates based on the configurations, which is also referred to as PDCCH monitoring.

For a CORESET configured by the dedicated RRC signaling, one or more transmission configuration indicator (TCI) states may be configured as part of the CORESET configuration, and a MAC CE may be used to indicate the TCI state that is applied to the CORESET when more than one TCI states are configured for the CORESET. A TCI state may be associated with one or two reference signals, which may be used as references for the channel estimation and the spatial filtering. The CORESET may be quasi co-located (QCLed) with the reference signals (e.g., SSBs or CSI-RSs) which are associated with the TCI state. The reference signals may be the QCL sources of the CORESET. In other words, the UE may receive a CORESET with the same receiving beam as that used for receiving the reference signal associated with the TCI state applied for the CORESET. For a CORESET configured by the MIB or SIB, different monitoring occasions of a CSS associated with the CORESET may be QCLed with different SSBs. For example, for receiving Type-0 CSS associated with CORESET 0, when a monitoring occasion has a time offset from an SSB, the monitoring occasion may be received assuming the CORESET is QCLed with the SSB, and the time offset may be determined by the configuration provided by the MIB.

For a PDSCH, one or more TCI states may be configured by the dedicated RRC signaling, and a MAC CE may be used to map up to 8 TCI states to up to 8 codepoints of a TCI field in the DCI format 1_1 or the DCI format 1_2. For a PDSCH scheduled by a DCI format, the TCI state applied for the PDSCH may be indicated by the TCU field of the DCI format. For a CSI-RS resource, a TCI state applied for the CSI-RS resource may configured by the RRC signaling.

For a PUSCH, one or more SRS resources may be configured to be associated with the PUSCH, and the DCI format scheduling the PUSCH may indicate an SRS resource from the SRS resources. The one or more SRS resources may be transmitted to the gNB for the channel sounding before the PUSCH transmission. The SRS resources may be configured with associated spatial relations, and a spatial relation may define the QCL source of the associated SRS resource. The QCL source of the PUSCH may be determined as the QCL source of the SRS resource indicated by the scheduling DCI. For a CG PUSCH, the SRS resource may be configured by the RRC signaling or indicated by the activation DCI. For a PUCCH, a spatial relation may be configured by the RRC signaling, and the spatial relation may define the QCL source of the PUCCH.

The possible combinations of the DCI formats monitored in a UE-specific search space may include {DCI format 0_0, DCI format 1_0}, {DCI format 0_1, DCI format 1_1}, {DCI format 0_2, DCI format 1_2}, and {DCI format 0_1, DCI format 1_1, DCI format 0_2, DCI format 1_2}. The DCI format 0_0, the DCI format 0_1, and the DCI format 0_2 may be used for scheduling the PUSCH, while the DCI format 1_0, the DCI format 1_1, and the DCI format 1_2 may be used for scheduling the PDSCH. For a DCI format monitored in a USS, the CRC of the DCI format may be scrambled by the C-RNTI, the CS-RNTI, or the MCS-C-RNTI. When the CRC of a DCI format 0_0, a DCI format 0_1, or a DCI format 0_2 is scrambled by the CS-RNTI, the PUSCH transmission scheduled by the DCI format may be a retransmission of a CG PUSCH if the NDI field of the DCI format is set to 1. In a Type-3 CSS, a UE may be configured to monitor the DCI format 0_0 and the DCI format 1_0. In addition, the UE may be configured to monitor the DCI format 2_X (e.g., the DCI format 2_0, the DCI format 2_1, the DCI format 2_2, the DCI format 2_3, and the DCI format 2_4) in the Type-3 CSS.

The NR Rel-16 introduces two physical layer priorities that include “high priority” (e.g., priority index 1, p1) and “low priority level” (e.g., priority index 0, p0). The physical layer priority of a PUCCH/PUSCH may be assigned by the network via the RRC signaling or L1 message (e.g., via priority indicator in the DCI format 0_1, the DCI format 1_1, the DCI format 0_2, or the DCI format 1_2). A PUCCH/PUSCH associated with high priority may also be referred to as a high priority PUCCH/PUSCH. A PUCCH/PUSCH associated with low priority may also be referred to as a low priority PUCCH/PUSCH. A PUCCH for the HARQ-ACK may be associated with the high priority if the scheduling DCI for the corresponding PDSCH indicates the high priority, and a PUCCH for the HARQ-ACK may be associated with the low priority if the scheduling DCI for the corresponding PDSCH indicates the low priority. A PUCCH for the SR or the LRR may be associated with the high priority if phy-PriorityIndex-r16 of the SR resource configuration indicates p1, while a PUCCH for the SR or the LRR may be associated with the low priority if phy-PriorityIndex-r16 of the SR resource configuration indicates p0.

In NR, a UE may be provided with one or more configured grants (CGs). The CG may include a Type-1 CG or a Type-2 CG. For a Type-1 CG, the UE may directly use the CG for the uplink transmission after receiving the CG configuration. For a Type-2 CG, the UE may not directly use the CG for the uplink transmission after receiving the CG configuration. To use the CG for the uplink transmission, the UE may need to receive an activation DCI activating the CG. Specifically, the activation DCI may include a DCI format 0_0, a DCI format 0_1, or a DCI format 0_2 with CRC scrambled by the CS-RNTI, and the NDI field of the DCI format may be set to 0. A CG configuration may include one or more of the following configurations: the time domain symbol allocation, the frequency resource allocation, the DMRS configuration, the modulation and coding scheme (MCS), the periodicity, a number of repetitions, a number of HARQ processes, and the transform precoding. The PUSCH occasions configured by the CG configuration may occur periodically in time domain with the configured periodicity. Within each period, there may be the PUSCH occasions in consecutive slots when the number of repetitions is greater than 1, and the number of consecutive slots may be equal to the number of repetitions. That is to say, one slot may include one PUSCH occasion which is used for one repetition, and each PUSCH occasion may be with the same symbol allocation. The HARQ process ID for a PUSCH occasion may be determined based on the system frame number and the slot number corresponding to the slot in which the PUSCH occasion is located. Specifically, the HARQ process ID associated with the first symbol of an UL transmission may be determined based on the following formula:

$$HARQ Process ID = [ floor ( CURRENT\_symbol / periodicity ) ] modulo nrofHARQ - Processes$$

Where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot may be referred to as the number of consecutive slots per frame and the number of consecutive symbols per slot, respectively.

In NR Rel-15, a CG configuration may be configured in an UL BWP of a UE. In NR Rel-16, to better support a UE with more than one IIoT services, each of which having a different performance requirement (e.g., reliability and latency), up to 12 CG configurations may be configured in an UL BWP for a UE. To reduce signaling overhead for releasing the CG PUSCHs of multiple CG configurations, joint release of the CG PUSCHs of multiple CG configurations via a single DCI may be supported.

A UE may be provided with one or more SPS configurations. To use an SPS configuration, the UE may need to receive an activation DCI activating the SPS configuration. An SPS configuration may include one or more of the following configurations: the periodicity, a number of repetitions, a number of HARQ processes, and the PUCCH resource for the SPS HARQ-ACK (configured by n1PUCCH-AN). The activation DCI may include a DCI format 1_0, a DCI format 1_1, or a DCI format 1_2 with CRC scrambled by the CS-RNTI, and the NDI field of the DCI format may be set to 0. The activation DCI may provide the configurations for the SPS PDSCH, such as the time domain symbol allocation, the frequency resource allocation, and the MCS.

The SPS PDSCHs may occur periodically in time domain with the configured periodicity. Within each period, there may be the SPS PDSCHs in consecutive slots when the number of repetitions is greater than 1, and the number of consecutive slots may be equal to the number of repetitions. That is to say, one slot may include one SPS PDSCH which may be used for one repetition, and each SPS PDSCH occasion may be with the same symbol allocation.

For an SPS PDSCH ending in slot n, a UE may transmit a PUCCH in slot n+k, and k may be provided by a PDSCH-to-HARQ_feedback timing indicator field, if present, in a DCI format activating the SPS PDSCH. The PUCCH may be provided by n1PUCCH-AN. For reporting a HARQ-ACK for an SPS PDSCH of multiple SPS configurations on a PUCCH configured for an SPS HARQ-ACK, multiple PUCCH resources may be configured by an SPS-PUCCH-AN-List per HARQ-ACK codebook, and the actual PUCCH resource to be used among PUCCH resources may be determined based on the HARQ-ACK payload size as described below.

In a slot or a sub-slot, the UE may generate up to two HARQ-ACK codebooks. The two HARQ-ACK codebooks may be transmitted separately in separate PUCCHs, each associated with respective HARQ-ACK codebook.

More specifically, if a UE is provided with the pdsch-HARQ-ACK-Codebook-List, the UE may be indicated by pdsch-HARQ-ACK-Codebook-List to generate one or two HARQ-ACK codebooks. If the UE is indicated to generate one HARQ-ACK codebook, the HARQ-ACK codebook may be associated with a PUCCH of priority index 0 which is also referred to as a low priority PUCCH. If a UE is provided with the pdsch-HARQ-ACK-Codebook-List, the UE may multiplex in a same HARQ-ACK codebook only HARQ-ACK information associated with a same (physical layer) priority index. If the UE is indicated to generate two HARQ-ACK codebooks, (a) a first HARQ-ACK codebook may be associated with a PUCCH of priority index 0 and a second HARQ-ACK codebook may be associated with a PUCCH of priority index 1, which is also referred to as a high priority PUCCH, and/or (b) the UE may be provided with first and second for each of {PUCCH-Config, UCI-OnPUSCH, PDSCH-codeBlockGroupTransmission} by {PUCCHConfigurationList, UCI-OnPUSCH-List, PDSCH-CodeBlockGroupTransmission-List}, respectively, for use with the first and second HARQ-ACK codebooks, respectively.

The pdsch-HARQ-ACK-Codebook-List may provide the types of the first HARQ-ACK codebook and the second HARQ-ACK codebook. Each HARQ-ACK codebook may be configured as a semi-static HARQ-ACK codebook which is also referred to as a Type-1 HARQ-ACK codebook, or may be configured as a dynamic HARQ-ACK codebook which is also referred to as a Type-2 HARQ-ACK codebook. The first PUCCH-Config may be used to configure the low priority PUCCH resources and the second PUCCH-Config may be used to configure the high priority PUCCH resources. A sub-slot configuration may be included in a PUCCH-Config. Two 7-symbol sub-slots or seven 2-symbol sub-slots may be configured in a slot. If a sub-slot configuration is included in the first PUCCH-Config, a low priority HARQ-ACK codebook may be transmitted in a low priority PUCCH in a sub-slot defined by the sub-slot configuration. If a sub-slot configuration is included in the second PUCCH-Config, a high priority HARQ-ACK codebook may be transmitted in a high priority PUCCH in a sub-slot defined by the sub-slot configuration. The priority of a HARQ-ACK corresponding to a PDSCH may be explicitly indicated by a field in the DCI format 1_1 or the DCI format 1_2 scheduling the PDSCH. The priority of a HARQ-ACK corresponding to a PDSCH may be implicitly determined as low priority if the PDSCH is scheduled by a DCI format 1_0.

The slot in which the PUCCH is transmitted may be K1 slots from the slot where the DCI format is received, and K1 may be a value selected from the dl-DataToUL-ACK, the dl-DataToUL-ACK-r16, or the DL-DataToUL-ACK-ForDCI-Format1-2-r16 configured in the PUCCH-Config associated with the priority indicated by or associated with the DCI format, and K1 may be selected based on the PDSCH-to-HARQ_feedback timing indicator field in the DCI format. Furthermore, if the PUCCH-Config is configured with the subslotLengthForPUCCH-r16, the offset may be in unit of subslot of the length configured by the subslotLengthForPUCCH-r16. The reference slot or reference subslot for counting the slot offset or the subslot offset may be the UL slot or the UL subslot overlapping with the end of the PDSCH scheduled by the DCI format, if a PDSCH is scheduled by the DCI format. The reference slot or the reference subslot for counting the slot offset or the subslot offset may be the UL slot or the UL subslot overlapping with the end of the DCI format, if no PDSCH is scheduled by the DCI format.

In Rel-15 NR, different PUCCH resource may be configured with different starting symbols in a slot. A set of PUCCH resources may be defined and a UCI multiplexing procedure may perform the step 1 to step 3 iteratively over the set of PUCCH resources (e.g., the PUCCH resource set Q) as described in the following. To define the set of PUCCH resources, the UE may determine up to two CSI PUCCH resources in the slot with the highest CSI priorities and with at most one CSI PUCCH resource being PUCCH format 3 or PUCCH format 4 when the following (i) or (ii) is fulfilled. (i) When the multi-CSI-PUCCH-ResourceList is not configured. (ii) When there are no overlapping CSI PUCCH resources in the slot and when multi-CSI-PUCCH-ResourceList is configured.

The UE may determine a PUCCH resource from the multi-CSI-PUCCH-ResourceList to multiplex all CSI of the CSI PUCCH resources in the slot when there are overlapping CSI PUCCH resources in the slot and when multi-CSI-PUCCH-ResourceList is configured. Up to two CSI PUCCH resources may be included in the set of PUCCH resources as described above. If a PUCCH resource for the HARQ-ACK is scheduled in the slot, the PUCCH resource for the HARQ-ACK to be included in the set of PUCCH resources may be determined as the PUCCH resource selected from a PUCCH resource set based on the PRI in the scheduling DCI, and the PUCCH resource set may be determined based on the payload size of the HARQ-ACK. If an SPS HARQ-ACK PUCCH resource is configured in the slot, it may be included in the set of PUCCH resources. If an SR PUCCH resource is with negative SR and does not overlap with any of the CSI PUCCH resources, the HARQ-ACK PUCCH resource, or the SPS HARQ-ACK PUCCH resource described above, the SR PUCCH resource may not be included in the set of PUCCH resources. Otherwise, the SR PUCCH resource may be included in the set of PUCCH resources.

The following UCI multiplexing procedure may be performed over the set of PUCCH resources. In other words, any PUCCH resource described below may be included in the set of PUCCH resources except for the case where a new PUCCH resource set needs to be determined for selection of the PUCCH resource for the HARQ-ACK and other UCI when the HARQ-ACK PUCCH resource of the original PUCCH resource set cannot accommodate the HARQ-ACK and other UCI as described in step 2 and step 3 below.

In step 1, a first PUCCH resource with the earliest starting symbol and longest duration in the slot may be determined, and a first group of overlapping PUCCH resources may be formed, which includes the first PUCCH resource and the PUCCH resources overlapping with the first PUCCH resource.

In step 2, a second PUCCH resource may be determined to multiplex the UCIs of the first group of overlapping PUCCH resources by selecting one PUCCH resource from the first group of overlapping PUCCH resources by one of the following two methods (i) and (ii). (i) The second PUCCH resource may be determined by some rules for multiplexing the UCI of overlapping PUCCH resources which depends on the types of the UCI and the PUCCH formats of the PUCCH resources when the first group of overlapping PUCCH resources does not include a HARQ-ACK PUCCH resource scheduled by the DCI. (ii) The second PUCCH resource may be determined by selecting a PUCCH resource based on the PRI and the payload size of the UCI of the first group of overlapping PUCCH resources when a HARQ-ACK PUCCH resource scheduled by the DCI is in the first group of overlapping PUCCH resources. Specifically, when the payload size can be accommodated by the HARQ-ACK PUCCH resource, the HARQ-ACK PUCCH resource may be determined as the second PUCCH resource used for multiplexing the UCI. On the other hand, when the payload size cannot be accommodated by the PUCCH resource set including the HARQ-ACK PUCCH resource, a PUCCH resource set may be determined based on the payload size of the UCI of the first group of overlapping PUCCH resources, and the second PUCCH resource may be determined by selecting a PUCCH resource from the PUCCH resource set based on the PRI.

In step 3, the PUCCH resources in the first group of overlapping PUCCH resources may be excluded from the set of PUCCH resources except for the second PUCCH resource, and in case the second PUCCH resource was not included in the set of PUCCH resources (in case the second PUCCH resource is determined based on the PRI from a second PUCCH resource set when the payload size of the UCI of the first group of overlapping PUCCH resources cannot be accommodated by a first PUCCH resource set that includes the HARQ-ACK PUCCH resource in the first group of overlapping PUCCH resources), the second PUCCH resource may be included in the set of PUCCH resources. The UCI multiplexing procedure then may proceed to determine a second group of overlapping PUCCH resources from the remaining PUCCH resources in the set of PUCCH resources, and a third PUCCH resource may be determined to multiplex the UCI of the second group of overlapping PUCCH resources as the method in step 1 and step 2 for determining the first group of overlapping PUCCH resources and the second PUCCH resource for multiplexing the UCI of the first group of overlapping PUCCH resources. The multiplexing procedure may be performed iteratively until at most two non-overlapping PUCCH resources are determined.

It may be noted that when a PUCCH resource (e.g., the second PUCCH resource or the third PUCCH resource) is selected from a group of overlapping PUCCH resources including a PUCCH resource for the HARQ-ACK scheduled by the DCI, the PUCCH resource may be determined based on the PRI in the scheduling DCI, and the PRI may indicate the index corresponding to the order of the determined PUCCH resource in a PUCCH resource set, and the PUCCH resource set may be determined by the payload size of the HARQ-ACK and other UCI in the group of overlapping PUCCH resources. Specifically, the PUCCH resource set may be determined as the following.

If the UE transmits O_{UCI} UCI information bits, that include HARQ-ACK information bits, the UE may determine a PUCCH resource set to be one of the following (a)-(d).
(a) a first set of PUCCH resources with pucch-ResourceSetId=0 if O_{UCI}≤2 including 1 or 2 HARQ-ACK information bits and a positive or negative SR on one SR transmission occasion if transmission of HARQ-ACK information and SR occurs simultaneously,
(b) a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706,
(c) a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, and
(d) a fourth set of PUCCH resources with pucch-ResourceSetId=3, if provided by higher layers, if N₃<O_{UCI}≤1706.

Where O_{UCI} is the total payload size of the multiplexed UCI.

After the multiplexed UCIs and the PUCCH carrying the multiplexed UCIs are determined, the UE may multiplex the multiplexed UCI on a PUSCH if the PUCCH carrying the multiplexed UCIs overlaps with the PUSCH in time domain.

If a PUCCH resource is used only for the HARQ-ACK transmission with the O_{ACK} HARQ-ACK information bits and the O_{CRC} bits using the PUCCH format 2 or the PUCCH format 3 in a PUCCH resource that includes the

$${M}_{RB}^{PUCCH} PRBs ,$$

the UE may determine a number of

$$PRBs {M}_{RB , min}^{PUCCH}$$

for the PUCCH transmission to be the minimum number of PRBs, that is smaller than or equal to a number of

$$PRBs {M}_{RB}^{PUCCH}$$

provided respectively by the nrofPRBs of the PUCCH-format2 or the nrofPRBs of the PUCCH-format3 and start from the first PRB from the number of PRBs, that results to

$$( {O}_{ACK} + {O}_{CRC} ) \leq {M}_{RB , min}^{PUCCH} \cdot {N}_{sc , ctrl}^{RB} \cdot {N}_{symb - UCI}^{PUCCH} \cdot {Q}_{m} \cdot r$$

and, if

$${M}_{RB}^{PUCCH} > 1 , ( {O}_{ACK} + {O}_{CRC} ) > ( {M}_{RB , min}^{PUCCH} - 1 ) \cdot {N}_{sc , ctrl}^{RB} \cdot {N}_{symb - UCI}^{PUCCH} \cdot {Q}_{m} \cdot r , \\ where {N}_{sc , ctrl}^{RB} , {N}_{symb - UCI}^{PUCCH} ,$$

Qₘ, and r may be defined in the 3GPP TS 38.213. For PUCCH format 3, if

$${M}_{RB , min}^{PUCCH}$$

is not equal 2^{a}^{₂}·3^{a}^{₃}·5^{a}^{₅} according to the 3GPP TS 38.211,

$${M}_{RB , min}^{PUCCH}$$

may be increased to the nearest allowed value of the nrofPRBs for the PUCCH-format3. If

$$( {O}_{ACK} + {O}_{CRC} ) > ( {M}_{RB}^{PUCCH} - 1 ) \cdot {N}_{sc , ctrl}^{RB} \cdot {N}_{symb - UCI}^{PUCCH} \cdot {Q}_{m} \cdot r ,$$

the UE may transmit the PUCCH over

$${M}_{RB}^{PUCCH} PRBs .$$

When it is determined to use a PUCCH resource configured by the multi-CSI-PUCCH-ResourceList to multiplex all the CSI reports of the CSI PUCCH resources and the HARQ-ACK/SR information in the slot, and the HARQ-ACK, if any, is in response to a PDSCH reception without a corresponding PDCCH, the PUCCH resource and the number of PRBs for the PUCCH resource may be determined as the following.

The UE is provided by the multi-CSI-PUCCH-ResourceList with J≤2 PUCCH resources in a slot, for the PUCCH format 2, the PUCCH format 3, and/or the PUCCH format 4, where the resources are indexed according to an ascending order for the product of a number of corresponding REs, modulation order Qₘ, and configured code rate r.
if

$$( {O}_{ACK} + {O}_{SR} + {O}_{CSI} + {O}_{CRC} ) \leq {( {M}_{RB}^{PUCCH} \cdot {N}_{sc , ctrl}^{RB} \cdot {N}_{symb - UCI}^{PUCCH} \cdot {Q}_{m} \cdot r )}_{0} ,$$

the UE may use the PUCCH format 2 resource 0, or the PUCCH format 3 resource 0, or the PUCCH format 4 resource 0;
else if

$$( {O}_{ACK} + {O}_{SR} + {O}_{CSI} + {O}_{CRC} ) > {( {M}_{RB}^{PUCCH} \cdot {N}_{sc , ctrl}^{RB} \cdot {N}_{symb - UCI}^{PUCCH} \cdot {Q}_{m} \cdot r )}_{j} and$$

$$( {O}_{ACK} + {O}_{SR} + {O}_{CSI} + {O}_{CRC} ) \leq {( {M}_{RB}^{PUCCH} \cdot {N}_{sc , ctrl}^{RB} \cdot {N}_{symb - UCI}^{PUCCH} \cdot {Q}_{m} \cdot r )}_{j + 1} , \\ 0 \leq j < J - 1 ,$$

the UE may transmit a PUCCH conveying the HARQ-ACK information, the SR and the CSI report(s) in a respective PUCCH where the UE uses the PUCCH format 2 resource j+1, or the PUCCH format 3 resource j+1, or the PUCCH format 4 resource j+1;
else the UE may use the PUCCH format 2 resource J−1, or the PUCCH format 3 resource J−1, or the PUCCH format 4 resource J−1 and the UE may select

$${N}_{CSI}^{reported}$$

CSI report(s) for the transmission together with the HARQ-ACK information and the SR, when any, in ascending priority value as specified in the 3GPP TS 38.214

If the UE is provided the SPS-PUCCH-AN-List-r16 and transmits O_{UCI} UCI information bits that include only the HARQ-ACK information bits in response to one or more SPS PDSCH receptions, the UE may determine a PUCCH resource to be one of the following (a)-(d).
(a) a PUCCH resource provided by the sps-PUCCH-AN-ResourceID obtained from the first entry in the sps-PUCCH-AN-List-r16 if O_{UCI}≤2,
(b) a PUCCH resource provided by the sps-PUCCH-AN-ResourceID obtained from the second entry in the sps-PUCCH-AN-List-r16, if provided, if 2<O_{UCI}≤N_{1,SPS} where N_{1,SPS} is either provided by the maxPayloadSize obtained from the second entry in the sps-PUCCH-AN-List-r16 or is otherwise equal to 1706,
(c) a PUCCH resource provided by the sps-PUCCH-AN-ResourceID obtained from the third entry in the sps-PUCCH-AN-List-r16, if provided, if N_{1,SPS}<O_{UCI}≤N_{2,SPS} where N_{2,SPS} is either provided by the maxPayloadSize obtained from the third entry in the sps-PUCCH-AN-List-r16 or is otherwise equal to 1706, and
(d) a PUCCH resource provided by the sps-PUCCH-AN-ResourceID obtained from the fourth entry in the sps-PUCCH-AN-List-r16, if provided, if N_{2,SPS}<O_{UCI}≤N_{3,SPS} where N_{3,SPS} is equal to 1706.

When a PUCCH of a priority overlaps with a PUSCH of the same priority, the UCIs that was to be transmitted in the PUCCH may be multiplexed in the PUSCH. More specifically, the PUCCH may be a PUCCH used for multiplexing UCIs of multiple overlapping PUCCHs, and the PUCCH may be determined by performing a UCI multiplexing procedure on the multiple overlapping PUCCHs. When the multiplexed UCIs in the PUCCH includes scheduling request (SR), the SR may be dropped. That is, the HARQ-ACK and the CSI may be multiplexed in the PUSCH and the SR may not be multiplexed in the PUSCH. When the PUCCH overlaps with multiple PUSCHs, the UE may multiplex the UCIs that was to be transmitted in the PUCCH in one PUSCH of the multiple PUSCHs. The UE may determine the one PUSCH by considering the following priorities. That is, a PUSCH with higher priority may be considered for multiplexing the UCIs before a PUSCH with lower priority.

First priority: The PUSCH with A-CSI as long as it overlaps with the PUCCH.

Second priority: The earliest PUSCH slot(s) based on the start of the slot(s).

If there are still multiple PUSCHs overlap with the PUCCH in the earliest PUSCH slot(s), follow the following priorities (sequentially from high to low).

Third priority: The dynamic grant PUSCHs>the PUSCHs configured by respective ConfiguredGrantConfig or semiPersistentOnPUSCH.

Fourth priority: The PUSCHs on serving cell with smaller serving cell index>the PUSCHs on serving cell with larger serving cell index.

Fifth priority: Earlier PUSCH transmission>later PUSCH transmission.

In NR, the slot format of a slot may be indicated by the RRC configuration. The RRC configuration may include the TDD configuration. In addition to the RRC configuration, the DCI may be used to indicate the slot format of a slot. The RRC configuration may be configured via the SIB1, (e.g., via the TDD-UL-DL-ConfigCommon IE) and optionally via a dedicated RRC message (e.g., via the TDD-UL-DL-ConfigDedicated IE).

The TDD-UL-DL-ConfigCommon may configure a periodicity, a number of downlink symbols, a number uplink symbols, and a number of flexible symbols within a period with length equal to the periodicity. The pattern of downlink symbols, uplink symbols, and flexible symbols may be repeated with the periodicity. The downlink symbols within a period may be located consecutively from the start of the period. The number of downlink symbols may be configured via the nrofDownlinkSlots which indicates the number of slots with all downlink symbols and the nrofDownlinkSymbols which indicates the number of downlink symbols in the slot after the last slot with all downlink symbols. The uplink symbols within a period may be located consecutively at the end of the period. The number of uplink symbols may be configured via the nrofUplinkSlots which indicates the number of slots with all uplink symbols at the end of the period and the nrofUplinkSymbols which indicates the number of uplink symbols in the slot before the first slot with all uplink symbols.

If there are symbols in the period that are not indicated as either downlink symbols or uplink symbols, they may be defined as the flexible symbols. The flexible symbols may be located consecutively between the downlink symbols and the uplink symbols within the period. If a UE is provided with the TDD-UL-DL-ConfigDedicated, the TDD-UL-DL-ConfigDedicated may configure the slot formats of specific slots. The specific slots may be explicitly indicated via a slot index included in the TDD-UL-DL-ConfigDedicated and the specific slots may be a subset of the slots with at least one flexible symbol configured via the TDD-UL-DL-ConfigCommon. In other words, the TDD-UL-DL-ConfigDedicated may be used to further indicate the directions of a subset of the flexible symbols configured via the TDD-UL-DL-ConfigCommon. A flexible symbol may be indicated as the downlink symbol, the uplink symbol, or the flexible symbols via the TDD-UL-DL-ConfigDedicated. Specifically, a specific slot may be indicated as a slot with all downlink symbols, a slot with all uplink symbols, or a slot with a number of downlink symbols in the front of the slot and a number of uplink symbols at the end of the slot. If there are symbols in the slot that are not indicated as either downlink symbols or uplink symbols, they may be defined as the flexible symbols.

The downlink symbols, the uplink symbols and the flexible symbols configured via the TDD-UL-DL-ConfigCommon and optionally via the TDD-UL-DL-ConfigDedicated may be also referred to as the semi-static downlink symbols, the semi-static uplink symbols, and the semi-static flexible symbols, respectively.

A DCI format 2_0 may be used to indicate the slot formats of a number of slots in one or more cells. The DCI format 2_0 may be also referred to as a slot format indicator (SFI). The UE may be configured with a Type-3 CSS in one cell in which the UE should monitor the DCI format 2_0. The DCI format 2_0 may include one or more SFI-index fields, each may indicate slot formats of one or more slots of a specific serving cell. The position of an SFI-index field in a DCI format 2_0 and the specific serving cell to which the SFI-index is applied may be preconfigured. One or more combinations of slot formats may be configured, and each combination of slot formats may be associated with a value.

An SFI-index field may indicate the value associated with a combination of slot formats of one or more slots, and each slot format of the combination of slot formats may be associated with one slot. The indicated combination of slot formats may be applied to the slots starting from the slot in which the DCI format 2_0 is received. In other words, if DCI format 2_0 is received in slot n, the first slot format of the indicated combination of slot formats may be applied to slot n, and the second slot format of the indicated combination of slot formats may be applied to slot n+1, and so on.

A slot format of a slot in the combination of slot formats may be indicated by a value which is an index to a row of a predefined table, and each row of the predefined table may define the symbol direction (e.g., the downlink, uplink, or flexible symbols) of each symbol in the slot. When a slot format of a slot is indicated by a value of 255, the symbol directions of each symbol of the slot may be determined based on the semi-static symbol directions configured via the TDD-UL-DL-ConfigCommon and optionally via the TDD-UL-DL-ConfigDedicated. For a serving cell operating in the TDD, if the serving cell is configured with two uplink carriers (e.g., the normal uplink carrier (NUL) and supplementary uplink carrier (SUL)), the DCI format 2_0 may indicate the slot formats of both carriers. For a serving cell operating in the FDD, the DCI format 2_0 may indicate the slot formats of both the DL and UL carriers.

For a set of semi-static DL symbols or semi-static flexible symbols, when the UE detects a DCI format 2_0 indicating slot formats of the set of symbols and if a configured uplink transmission (e.g., PUSCH, PUCCH, PRACH, or SRS) is included in the set of symbols, the UE may transmit the configured uplink transmission if the symbols including the configured uplink transmission are indicated by the DCI format 2_0 as the uplink symbols.

For a set of semi-static DL symbols or semi-static flexible symbols, when the UE does not detect a DCI format 2_0 indicating slot formats of the set of symbols and if a configured uplink transmission (e.g., PUSCH, PUCCH, PRACH, or SRS) is included in the set of symbols and the last symbol of a CORESET in which the UE attempted to detect a DCI format 2_0 candidate is at least a time duration before the first symbol including the configured uplink transmission, the UE may transmit the configured uplink transmission. The time duration may be equal to T_{proc,2}.

For a set of semi-static DL symbols or semi-static flexible symbols, when the UE does not detect a DCI format 2_0 indicating slot formats of the set of symbols and if a configured uplink transmission (e.g., PUSCH, PUCCH, PRACH, or SRS) is included in the set of symbols and the last symbol of a CORESET in which the UE attempted to detect a DCI format 2_0 candidate is within a time duration before the first symbol including the configured uplink transmission, the UE may transmit the configured uplink transmission if the UE does not support a capability of partial cancellation. The time duration may be equal to T_{proc,2}.

For a set of semi-static DL symbols or semi-static flexible symbols, when the UE does not detect a DCI format 2_0 indicating slot formats of the set of symbols and if a configured uplink transmission (e.g., PUSCH, PUCCH, PRACH, or SRS) is included in the set of symbols and the last symbol of a CORESET in which the UE attempted to detect a DCI format 2_0 candidate is within a time duration before the first symbol including the configured uplink transmission, the UE may transmit partially the configured uplink transmission and cancel part of the configured UL transmission in symbols that are at least the time duration after the last symbol of the CORESET if the UE supports a capability of partial cancellation. The time duration may be equal to T_{proc,2}.

The time and frequency resources that can be used by the UE to report CSI may be controlled by the gNB. The CSI may include the Channel Quality Indicator (CQI), the precoding matrix indicator (PMI), the CSI-RS resource indicator (CRI), the SS/PBCH Block Resource indicator (SSBRI), the layer indicator (LI), the rank indicator (RI), the L1-RSRP, or the L1-SINR.

For CQI, PMI, CRI, SSBRI, LI, RI, LI-RSRP, a UE may be configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList).

Each trigger state in the CSI-AperiodicTriggerStateList may include a list of associated CSI-ReportConfigs indicating the Resource Set IDs for the channel and optionally for the interference. Each trigger state in the CSI-SemiPersistentOnPUSCH-TriggerStateList may include one associated CSI-ReportConfig.

Each Reporting Setting CSI-ReportConfig may be associated with a single downlink BWP (indicated by higher layer parameter BWP-Id) given in the associated CSI-ResourceConfig for the channel measurement and may include the parameter(s) for one CSI reporting band: the codebook configuration including codebook subset restriction, the time-domain behavior, the frequency granularity for the CQI and the PMI, the measurement restriction configurations, and the CSI-related quantities to be reported by the UE, such as the layer indicator (LI), the L1-RSRP, the L1-SINR, the CRI, and the SSBRI (SSB Resource Indicator) and Capability [Set] Index.

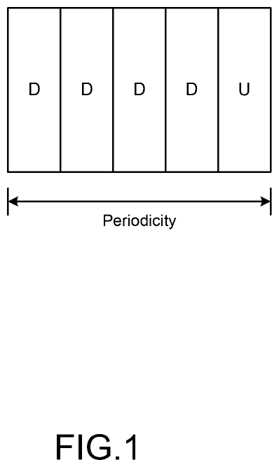

For a TDD carrier, the DL resource and the UL resource of the TDD carrier may be located in different time instances. An example of slot format which may be indicated based on the methods described above is shown in FIG. 1. FIG. 1 is a schematic diagram illustrating a slot format pattern for non-SBFD, according to an example implementation of the present disclosure. In FIG. 1, a slot format pattern with periodicity of 5 slots is shown, and the DL symbols are located in the first four slots within a period and the UL symbols are located in the last slot within the period. The slot format pattern may repeat with the periodicity.

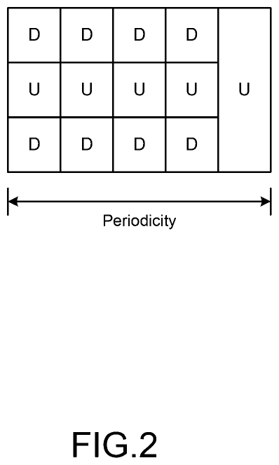

To allocate more UL resources for capacity and coverage enhancement for UL, full duplex may be performed at the gNB side. That is, the gNB may perform the DL transmission and the UL reception in the same resource. However, advanced techniques for self-interference cancellation may be required to cancel the self-interference caused by the DL transmission when receiving the UL transmission. In addition, CLI from other gNBs also may need to be mitigated for when receiving the UL transmission. High complexity of the gNB receiver may be foreseen to enable full duplex. FIG. 2 is a schematic diagram illustrating a slot format pattern for SBFD and non-SBFD, according to an example implementation of the present disclosure. On the other hand, the SBFD as shown in FIG. 2, may be a promising approach, since it greatly reduces implementation complexity in terms of self-interference cancellation and CLI mitigation at the gNB side by separating the DL and UL resources in different subbands. In FIG. 2, a slot format pattern with periodicity of 5 slots is shown, and there are three subbands (e.g., DL, UL, and DL subbands) in each of the first four symbols within a period, and an UL-only symbol is located in the last symbol within the period. There may be two options for indicating the frequency locations of the DL and UL subbands. In option 1, the frequency locations of the DL and UL subbands may be explicitly configured, while the frequency locations of guardbands may be implicitly derived. In option 2, the frequency locations of the UL subband and the number of RBs for guardbands may be explicitly configured, while the frequency locations of the DL subbands may be implicitly derived.

In the present disclosure, a symbol including the DL and UL subands may be referred to as a SBFD symbol. Otherwise, a symbol may be referred to as a non-SBFD symbol.

To enable SBFD, some issues, such as the slot format indications, the PUCCH resource allocations, and the DL/UL collisions, may need to be addressed.

A method for slot format indication may be needed to indicate slot formats for the SBFD operation. An RRC configuration may be used to indicate slot formats including the SBFD symbols and/or the non-SBFD symbols within a periodicity. In addition, a dynamic indication may be used to indicate slot formats including the SBFD symbols and/or the non-SBFD symbols within a time duration.

A PUCCH transmission may be included in either the non-SBFD symbols or the SBFD symbols since different transmission parameters may be applied for the PUCCH transmission in the non-SBFD symbols and in the SBFD symbols to handle interference. A method for the PUCCH resource allocations may be needed to allocate the PUCCH resources such that a PUCCH transmission occurs in either the non-SBFD symbols or the SBFD symbols.

Since there are both the DL and UL resource in a SBFD symbol, a UE may be configured or scheduled with a DL reception and an UL transmission in the same SBFD symbol. The situation may be referred to as the DL/UL collision. A method may be needed to resolve the DL/UL collision.

In the present disclosure, when it is described that a UE expects a specific condition, it may be equivalent as describing the gNB may meet the specific condition. The cell-specific slot formats may be configured via the SIB1 (e.g., via the TDD-UL-DL-ConfigCommon IE). The TDD-UL-DL-ConfigCommon may configure a periodicity, a number of downlink symbols, a number uplink symbols, and a number of flexible symbols within a period with length equal to the periodicity. The pattern of the downlink symbols, the uplink symbols, and the flexible symbols may be repeated with the periodicity. The downlink symbols within a period may be located consecutively from the start of the period. The number of downlink symbols may be configured via the nrofDownlinkSlots which indicates the number of slots with all downlink symbols and the nrofDownlinkSymbols which indicates the number of downlink symbols in the slot after the last slot with all downlink symbols. The uplink symbols within a period may be located consecutively at the end of the period. The number of uplink symbols may be configured via the nrofUplinkSlots which indicates the number of slots with all uplink symbols at the end of the period and the nrofUplinkSymbols which indicates the number of uplink symbols in the slot before the first slot with all uplink symbols. If there are symbols in the period that are not indicated as either the downlink symbols or the uplink symbols, they may be defined as the flexible symbols. The flexible symbols may be located consecutively between the downlink symbols and the uplink symbols within the period.

The frequency locations of the DL and UL subbands of a SBFD symbol may be configured via the dedicated RRC signaling. The same frequency locations of the DL and UL subbands may be applied to all SBFD symbol. Time locations of the SBFD symbols may be configured via the TDD-UL-DL-ConfigDedicated. The TDD-UL-DL-ConfigDedicated may configure the slot formats of specific slots. The specific slots may be explicitly indicated via a slot index included in the TDD-UL-DL-ConfigDedicated and the specific slots may be a subset of the slots with at least one flexible symbol or DL symbol configured via the TDD-UL-DL-ConfigCommon. In other words, the TDD-UL-DL-ConfigDedicated may be used to further indicate the directions of a subset of the flexible symbols or DL symbols configured via the TDD-UL-DL-ConfigCommon. A flexible symbol may be indicated as the downlink symbol, the uplink symbol, the flexible symbol, or the SBFD symbol via the TDD-UL-DL-ConfigDedicated.

The slot format of a specific slot may be indicated as a slot with all downlink symbols, a slot with all uplink symbols, or a slot with a number of downlink symbols in the front of the slot and a number of uplink symbols at the end of the slot. If there are symbols in the slot that are not indicated as either the downlink symbols or the uplink symbols, they may be defined as the flexible symbols. In addition, the slot formats of one or more specific slots may be indicated with a number of SBFD symbols, which are also referred to as the semi-static SBFD symbols. The number of SBFD symbols may be consecutive in time. A start symbol index may be used to indicate the symbol index of the first SBFD symbol in a specific slot. A length indicator may be used to indicate the number of consecutive SBFD symbols starting from the first SBFD symbol in the specific slot. The start symbol index and length indicator may be jointly indicated by one start symbol and length indicator. The symbols that may be indicated as the SBFD symbols may include the flexible symbols or the DL symbols configured via the TDD-UL-DL-ConfigCommon. The UE may not expect the gNB to configure a symbol as a SBFD symbol if the symbol is a symbol including a SSB transmission or a symbol within a number of symbols after the end of a SSB transmission. The number of symbols may be predefined or configured by the gNB.

To provide sufficient time for the SBFD symbol-to-DL symbol switching or the SBFD symbol-to-UL symbol switching, a number of reserved symbols which follow the SBFD symbols may be indicated via the TDD-UL-DL-ConfigDedicated. To provide sufficient time for the DL symbol-to-SBFD symbol switching, a number of reserved symbols which precede the SBFD symbols may be indicated via the TDD-UL-DL-ConfigDedicated. The reserved symbols may include the semi-static reserved symbols. The symbols that may be indicated as the reserved symbols may include the flexible symbols or the DL symbols configured via the TDD-UL-DL-ConfigCommon. The method may be also beneficial since a guard period may be created in a case that a N_{TA,offset} is applied for the UL transmission in the SBFD symbols, which is smaller than the N_{TA,offset} applied for the UL transmission in the non-SBFD symbols. For example, N_{TA,offset} applied for the UL transmission in the SBFD symbols may be 0 micro-seconds and N_{TA,offset} applied for the UL transmission in the non-SBFD symbols may be 13 micro-seconds.

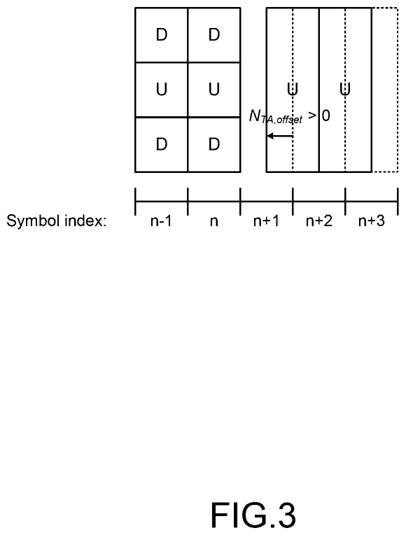

In some implementations, by indicating symbol n+1 as the reserved symbol, an UL transmission in the SBFD symbols which ends in symbol n may collide with another UL transmission in the non-SBFD symbols which starts in symbol n+2. FIG. 3 is a schematic diagram illustrating different N_{TA,offset} for non-SBFD and SBFD symbols, according to an example implementation of the present disclosure. An example is shown in FIG. 3. In FIG. 3, it may be assumed that N_{TA,offset} may be 0 micro-seconds for the UL transmission in the SBFD symbols and N_{TA,offset} may be greater than 0 micro-seconds for the UL transmission in the non-SBFD symbols. At the gNB side, the timing of the DL and UL subbands may be aligned in the SBFD symbols (e.g., symbol n−1 and symbol n). The symbol timing of the non-SBFD symbols with the uplink transmission (e.g., symbol n+2 and symbol n+3) may be advance in time since N_{TA,offset} is greater than 0. In the example, indicating symbol n+1 as a reserved symbol may prevent the UL transmission in the SBFD symbols interfering with the UL transmission in the non-SBFD symbols. For a configured UL transmission in an UL subband for the SBFD symbols, if the configured UL transmission is included in a reserved symbol, the UE may perform rate matching around the reserved symbol. In other words, the UE may not count the resource elements in the reserved symbol as valid when determining the TBS for the PUSCH transmission. In some implementations, the UE may perform an UL transmission in the SBFD symbols and drop or puncture in the reserved symbol. In some implementations, the UE may drop an UL transmission if the UL transmission is included in at least one reserved symbol.

For a set of semi-static SBFD symbols which are indicated as the DL symbols or the flexible symbols via the TDD-UL-DL-ConfigCommon, if the UE is configured to perform an UL transmission (e.g., a PUSCH, a PUCCH, or an SRS) in an UL subband in the set of symbols, the UE may cancel the UL transmission if a DCI format scheduling a DL reception is received, and the DL reception may be in a subset of symbols from the set of semi-static SBFD symbols. The UE may expect that the first symbol of the UL transmission is not within T_{proc,2} relative to the last symbol of the DCI format.

For a set of semi-static SBFD symbols which are indicated as the DL symbols or the flexible symbols via the TDD-UL-DL-ConfigCommon, if the UE is configured to perform a first DL reception (e.g., a PDSCH, a PDCCH, or a CSI-RS) in at least one DL subband in the set of symbols, the UE may not receive the first DL reception and the UE may receive a second DL reception if a DCI format scheduling the second DL reception is received, and the second DL reception may be in a subset of symbols from the set of semi-static SBFD symbols and at least a part of the second DL reception may not be within the DL subbands. The UE may expect that the first symbol of the second DL reception is not within a duration relative to the last symbol of the DCI format, and the duration may be configured by the gNB or may be determined based on the UE capability. In some implementations, the duration may be equal to T_{proc,2}. In some implementations, the UE may expect the reference signals associated with the TCI state of the first DL reception are the same as the reference signals associated with the TCI state of the second DL reception if the first symbol of the second DL reception is within the duration relative to the last symbol of the DCI format. In some implementations, the UE may expect the TCI state of the first DL reception is the same as the TCI state of the second DL reception if the first symbol of the second DL reception is within the duration relative to the last symbol of the DCI format.

For a set of semi-static SBFD symbols which are indicated as the flexible symbols via the TDD-UL-DL-ConfigCommon, if the UE is configured to perform a DL reception (e.g., a PDSCH, a PDCCH, or a CSI-RS) in at least one DL subband in the set of symbols, the UE may not perform the DL reception and the UE may transmit an UL transmission if a DCI format scheduling an UL transmission is received, and the UL transmission may be in a subset of symbols from the set of semi-static SBFD symbols and at least a part of the UL transmission may not be within the UL subband.

For a configured DL transmission, the gNB may configure the UE with different parameters for receiving the configured DL transmission in the non-SBFD symbols and for receiving the configured DL transmission in the SBFD symbols. The UE may apply parameters for the non-SBFD symbols if the configured DL transmission is received in the non-SBFD symbols. The UE may apply parameters for the SBFD symbols if the configured DL transmission is received in the SBFD symbols. For example, for a CORESET, the frequency resources, the precoder granularity, or the activated TCI state for the CORESET may be indicated differently for receiving the monitoring occasions in the non-SBFD symbols and the SBFD symbols. For another example, for an SPS configuration, the frequency resources, the MCS, or the TCI state applied to the associated SPS PDSCHs may be indicated differently for receiving the SPS PDSCHs in the non-SBFD symbols and the SBFD symbols. For another example, for a CSI-RS resource, the frequency resources or the TCI state applied to the CSI-RS resource may be indicated differently for receiving the CSI-RS in the non-SBFD symbols and the SBFD symbols.

For a configured UL transmission, the gNB may configure the UE with different parameters for transmitting the configured UL transmission in the non-SBFD symbols and for transmitting the configured UL transmission in the SBFD symbols. The UE may apply parameters for the non-SBFD symbols if the configured UL transmission is transmitted in the non-SBFD symbols. The UE may apply parameters for the SBFD symbols if the configured UL transmission is transmitted in the SBFD symbols. For example, for a CG configuration, the frequency resources, the power control parameters, the MCS, or the QCL source applied to the associated CG PUSCH may be indicated differently for transmitting the CG PUSCHs in the non-SBFD symbols and the SBFD symbols. For another example, for a PUCCH resource, the frequency resources, the power control parameters, or the QCL source applied to the PUCCH resource may be indicated differently for transmitting the PUCCH transmissions in the non-SBFD symbols and the SBFD symbols. For another example, for a SRS resource, the frequency resources or the QCL source applied to the SRS resource may be indicated differently for transmitting the SRS in the non-SBFD symbols and the SBFD symbols.

A DCI format may be used to dynamically indicate the slot formats of a number of slots in one or more cells. The DCI format may be a group common DCI format and the DCI format may be monitored by one or more UEs in a cell. The DCI format may include a DCI format 2_0 or a new DCI format (e.g., DCI format 2_X). The DCI format may be configured to be monitored in a Type-3 CSS or in a new type of CSS for the group common DCI format transmission.

The DCI format may include one or more SFI-index fields, and each SFI-index field may indicate the slot formats of one or more slots of a specific serving cell. The position of an SFI-index field in the DCI format and the specific serving cell to which the SFI-index is applied may be preconfigured. One or more combinations of slot formats may be configured, and each combination of slot formats may be associated with a value. An SFI-index field may indicate the value associated with a combination of slot formats of one or more slots, and each slot format of the combination of slot formats may be associated with one slot. The indicated combination of slot formats may be applied to slots starting from the slot in which the DCI format is received. In other words, if the DCI format is received in slot n, the first slot format of the indicated combination of slot formats may be applied to slot n, and the second slot format of the indicated combination of slot formats may be applied to slot n+1, and so on. A slot format of a slot in the combination of slot formats may be indicated by a value which is an index to a row of a predefined table, and each row of the predefined table may define the symbol directions (e.g., downlink (D), uplink (U), flexible (F), or SBFD(S) symbols) of each symbol in the slot. Table 1 below shows an example of a predefined table.

TABLE 1

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |
| 56 | S | S | S | S | S | S | S | S | S | S | S | S | S | S |
| 57 | D | F | S | S | S | S | S | S | S | S | S | S | S | S |
| 58 | D | D | F | S | S | S | S | S | S | S | S | S | S | S |
| 59 | D | D | D | F | S | S | S | S | S | S | S | S | S | S |
| 60 | D | F | S | S | S | S | S | S | S | S | S | S | S | F |
| 61 | D | D | F | S | S | S | S | S | S | S | S | S | S | F |
| 62 | D | D | D | F | S | S | S | S | S | S | S | S | S | F |
| 63 | D | F | S | S | S | S | S | S | S | S | S | S | F | U |
| 64 | D | D | F | S | S | S | S | S | S | S | S | S | F | U |
| 65 | D | D | D | F | S | S | S | S | S | S | S | S | F | U |

| | |
|---|---|
| 66-254 | Reserved |
| 255 | UE determines the slot format for the slot based on tdd-UL-DL- |
| | ConfigurationCommon, or tdd-UL-DL-ConfigurationDedicated and, if any, on |
| | detected DCI formats |

When a slot format of a slot is indicated by a value of 255, the symbol directions of each symbol of the slot may be determined based on the semi-static symbol directions configured via the TDD-UL-DL-ConfigCommon and optionally via the TDD-UL-DL-ConfigDedicated. For a serving cell operating in TDD, if the serving cell is configured with two uplink carriers (e.g., the normal uplink carrier (NUL) and the supplementary uplink carrier (SUL)), the DCI format may indicate the slot formats of both carriers.

For a set of semi-static SBFD symbols which are indicated as the flexible symbols via the TDD-UL-DL-ConfigCommon, the UE may cancel the UL transmission or the DL reception in the set of symbols if the DCI format is received with an SFI-index field value indicating a subset of the set of symbols as flexible. For a set of semi-static SBFD symbols which are indicated as the DL symbols via the TDD-UL-DL-ConfigCommon, the UE may expect to receive the DCI format with an SFI-index field value indicating the set of symbols of the slot as the DL, the SBFD, or the flexible. On the other hand, the UE may not expect to receive the DCI format with an SFI-index field value indicating the set of symbols of the slot as the UL. For a set of semi-static SBFD symbols which are indicated as flexible symbols via the TDD-UL-DL-ConfigCommon, the UE may expect to receive the DCI format with an SFI-index field value indicating the set of symbols of the slot as the DL, the UL, the SBFD, or the flexible. For a set of symbols of a slot, the UE may not expect to detect the DCI format with an SFI-index field value indicating the set of symbols of the slot as the downlink and to detect a DCI format 0_0, a DCI format 0_1, or a DCI format 0_2, indicating to the UE to transmit the PUSCH, the PUCCH, or the SRS in the set of symbols of the slot.

For a set of symbols of a slot, the UE may not expect to detect the DCI format with an SFI-index field value indicating the set of symbols of the slot as the SBFD and to detect a DCI format 0_0, a DCI format 0_1, or a DCI format 0_2, indicating to the UE to transmit the PUSCH, the PUCCH, or the SRS outside the UL subband in the set of symbols of the slot. For a set of symbols of a slot, the UE may not expect to detect the DCI format with an SFI-index field value indicating the set of symbols of the slot as the uplink and to detect a DCI format 1_0, a DCI format 1_1, a DCI format 1_2, a DCI format 0_1, or a DCI format 0_2, indicating to the UE to receive the PDSCH, or the CSI-RS in the set of symbols of the slot. For a set of symbols of a slot, the UE may not expect to detect the DCI format with an SFI-index field value indicating the set of symbols of the slot as the SBFD and to detect a DCI format 1_0, a DCI format 1_1, a DCI format 1_2, a DCI format 0_1, or a DCI format 0_2, indicating to the UE to receive the PDSCH, or the CSI-RS outside the DL subbands in the set of symbols of the slot.

For a set of semi-static SBFD symbols which are indicated as the DL symbols or the flexible symbols via the TDD-UL-DL-ConfigCommon, if the UE is configured to perform an UL transmission (e.g., a PUSCH, a PUCCH, or an SRS) in an UL subband in the set of symbols, the UE may cancel the UL transmission if the DCI format for the slot format indication is configured to be monitored and is received with an SFI-index field value indicating the set of symbols as the downlink. The UE may expect that the first symbol of the UL transmission is not within T_{proc,2} relative to the last symbol of the DCI format.

For a set of semi-static SBFD symbols which are indicated as the DL symbols or the flexible symbols via the TDD-UL-DL-ConfigCommon, if the UE is configured to perform a DL reception (e.g., a PDSCH, a PDCCH, or a CSI-RS) in at least one DL subband in the set of symbols, the UE may receive the DL reception based on the parameters for the non-SBFD symbols if the DCI format for the slot format indication is configured to be monitored and is received with an SFI-index field value indicating the set of symbols as the downlink if the first symbol of the DL reception is not within a duration relative to the last symbol of the DCI format. If the first symbol of the DL reception is within a duration relative to the last symbol of the DCI format, the UE may receive the DL reception based on the parameters for the SBFD symbols, and the duration may be configured by the gNB or may be determined based on the UE capability. In some implementations, the duration may be equal to T_{proc,2}.

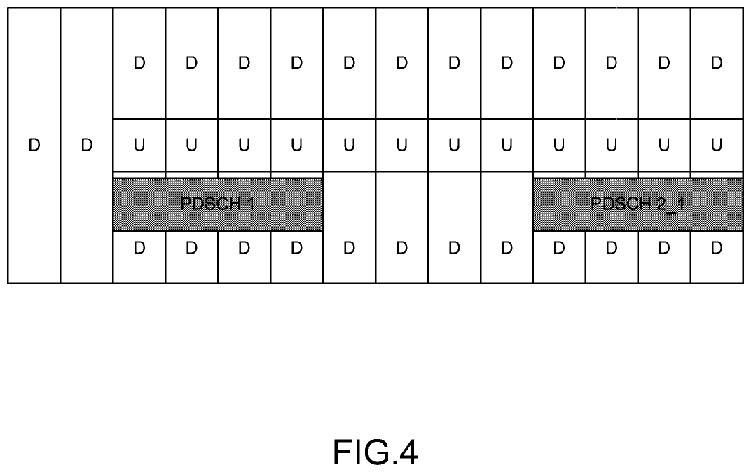

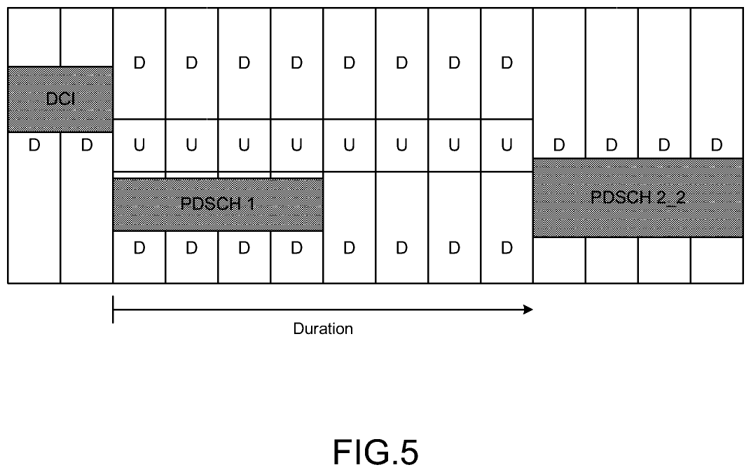

FIG. 4 is a schematic diagram illustrating configured DL receptions in DL subbands, according to an example implementation of the present disclosure. FIG. 5 is a schematic diagram illustrating that semi-static SBFD symbols are converted to DL symbols, according to an example implementation of the present disclosure. In FIG. 4, the PDSCH 1 and the PDSCH 2_1 may be configured to be received by the UE based on the parameters for the SBFD symbols. In FIG. 5, a DCI format indicating the slot formats may be received. Since the PDSCH 1 is within the duration from the end of the DCI format, it may be received based on the parameters for the SBFD symbols. On the other hand, since the DCI format indicates the symbols including the PDSCH 2_1 as the DL symbols and the PDSCH 2_1 is not within the duration from the end of the DCI format, the UE may receive the PDSCH 2_1 based on the parameters for the non-SBFD symbols. The frequency resource allocation may be different for the SBFD symbols and the non-SBFD symbols, and the frequency resource allocation for the non-SBFD symbols may be illustrated as the PDSCH 2_2.

For a set of semi-static SBFD symbols which are indicated as the flexible symbols via the TDD-UL-DL-ConfigCommon, if the UE is configured to perform an UL transmission (e.g., a PUSCH, a PUCCH, or an SRS) in an UL subband in the set of symbols, the UE may perform the UL transmission based on the parameters for the non-SBFD symbols if the DCI format for the slot format indication is configured to be monitored and is received with an SFI-index field value indicating the set of symbols as the uplink if the first symbol of the UL transmission is not within T_{proc,2} relative to the last symbol of the DCI format. If the first symbol of the UL transmission is within T_{proc,2} relative to the last symbol of the DCI format, the UE may transmit the UL transmission based on the parameters for the SBFD symbols.

For a set of semi-static SBFD symbols which are indicated as the DL symbols or the flexible symbols via the TDD-UL-DL-ConfigCommon, if the UE is configured to perform an UL transmission (e.g., a PUSCH, a PUCCH, or an SRS) in an UL subband in the set of symbols, the UE may cancel the UL transmission if the DCI format is not detected. The UE may expect that the first symbol of the UL transmission is not within T_{proc,2} relative to the last symbol of the CORESET in which the UE attempts to detect the DCI format.

For a set of semi-static SBFD symbols which are indicated as the DL symbols or the flexible symbols via the TDD-UL-DL-ConfigCommon, if the UE is configured to perform a DL reception (e.g., a PDSCH, a PDCCH, or a CSI-RS) in at least one DL subband in the set of symbols, the UE may receive the DL reception based on parameters for the SBFD symbols if the DCI format is not detected.

For a set of semi-static SBFD symbols which are indicated as the flexible symbols via the TDD-UL-DL-ConfigCommon, if the UE is configured to receive a DL reception (e.g., a PDSCH, a PDCCH, or a CSI-RS) in at least one DL subband in the set of symbols, the UE may cancel the DL reception if the DCI format for the slot format indication is configured to be monitored and is received with an SFI-index field value indicating the set of symbols as the uplink. The UE may expect that the first symbol of the DL reception is not within a duration relative to the last symbol of the DCI format, and the duration may be configured by the gNB or may be determined based on the UE capability. In some implementations, the duration may be equal to T_{proc,2}.

Two PUCCH resource configurations (e.g., one may correspond to the PUCCH resource configurations for the SBFD symbols and another may correspond to the PUCCH resource configurations for the non-SBFD symbols) may be configured for a BWP for a cell configured with the PUCCH resources. For PUCCH resources configured by different PUCCH resource configurations, the frequency resources, the power control parameters, or the QCL sources applied to the PUCCH resources may be configured differently. For example, a PUCCH resource configured by the PUCCH resource configuration for the SBFD symbols may be included in the frequency resources of an UL subband. For another example, a PUCCH resource configured by the PUCCH resource configuration for the SBFD symbols may be included in the SBFD symbols. For another example, a PUCCH resource configured by the PUCCH resource configuration for the SBFD symbols may or may not be included in the frequency resources of an UL subband. For another example, a PUCCH resource configured by the PUCCH resource configuration for the SBFD symbols may or may not be included in the SBFD symbols.

To determine a PUCCH resource for transmitting the HARQ-ACK for a PDSCH, a PUCCH resource configuration may be determined from the two PUCCH resource configurations, and a PUCCH resource indicator field in a DCI format scheduling the PDSCH may be used to indicate a PUCCH resource from one or more PUCCH resources configured by the PUCCH resource configuration. As described above, the PUCCH resource indicator field may indicate a PUCCH resource from a PUCCH resource set configured by the PUCCH resource configuration, and the PUCCH resource set may be determined based on the payload size of the UCI. To determine the PUCCH resource configurations from the two PUCCH resource configurations, one of the following (a)-(c) may be applied.

(a) The PUCCH resource configuration may be indicated via the DCI format scheduling the PDSCH associated with the HARQ-ACK.

(b) The PUCCH resource configuration may be determined based on whether the slot or the subslot indicated for the PUCCH transmission includes a SBFD symbol or not. For example, if the slot or the subslot indicated for the PUCCH transmission includes at least one SBFD symbol, the PUCCH resource configuration for the SBFD symbols may be determined to be used. Otherwise, the PUCCH resource configuration for the non-SBFD symbols may be determined to be used.

(c) The PUCCH resource configuration for the non-SBFD symbols may be determined to be used. When the PUCCH resource for the HARQ-ACK cannot be transmitted (e.g., if the PUCCH resource is included in the SBFD symbols and is not within the UL subband or if the PUCCH resource is included in both the SBFD and non-SBFD symbols), the PUCCH resource configuration for the SBFD symbols may be determined to be used.

For determining the PUCCH resource for the HARQ-ACK transmission for one or more SPS PDSCHs, the following (a) or (b) may be applied.

(a) The PUCCH resource for the HARQ-ACK transmission for one or more SPS PDSCHs may be configured via the n1PUCCH-AN in the SPS-Config or via the sps-PUCCH-AN-List-r16 in the PUCCH-Config. If the PUCCH resource is included in the SBFD symbols and is not within the UL subband or if the PUCCH resource is included in both the SBFD and non-SBFD symbols, the PUCCH transmission may be dropped. In some implementations, if the SPS HARQ-ACK deferral is configured, and if the PUCCH resource is included in the SBFD symbols and is not within the UL subband or if the PUCCH resource is included in both the SBFD and non-SBFD symbols, the SPS HARQ-ACK that was to be carried in the PUCCH resource may be deferred.

(b) The sps-PUCCH-AN-List may be configured in addition to the sps-PUCCH-AN-List-r16. In other words, two lists of PUCCH resources for the HARQ-ACK for the SPS PDSCH may be configured. In some implementations, a first list of PUCCH resources for the HARQ-ACK for the SPS PDSCH may be configured in the first PUCCH resource configuration for the non-SBFD symbols, and a second list of PUCCH resources for the HARQ-ACK for the SPS PDSCH may be configured in the second PUCCH resource configuration for the SBFD symbols. In some implementations, the UE may determine a PUCCH resource from the second list of PUCCH resources for the HARQ-ACK for the SPS PDSCH if the slot or the subslot in which the PUCCH is transmitted includes at least one SBFD symbol. Otherwise, the UE may determine a PUCCH resource from the first list of PUCCH resources for the HARQ-ACK for the SPS PDSCH. In some implementations, the UE may determine a PUCCH resource from the first list of PUCCH resources for the HARQ-ACK for the SPS PDSCH, and if the PUCCH resource is included in the SBFD symbols and is not within the UL subband or if the PUCCH resource is included in both the SBFD and non-SBFD symbols, the UE may determine another PUCCH resource from the second list of PUCCH resources for the HARQ-ACK for the SPS PDSCH.

For determining the PUCCH resource for the CSI report transmission, the following (a) or (b) may be applied.

(a) If the PUCCH resource CSI report transmission is not within the UL subband or if the PUCCH resource is included in both the SBFD and non-SBFD symbols, the PUCCH transmission may be dropped.

(b) In the CSI-ReportConfig, a list of PUCCH resources may be configured in addition to the list of PUCCH resources configured via the pucch-CSI-ResourceList. In other words, two lists of PUCCH resources may be configured. The first list of PUCCH resources may be the PUCCH resources configured via the pucch-CSI-ResourceList and may be a subset of PUCCH resources configured by the PUCCH resource configuration for non-SBFD symbols. The second list of PUCCH resources may be a subset of PUCCH resources configured by the PUCCH resource configuration for the SBFD symbols. In some implementations, the UE may determine a PUCCH resource from the second list of PUCCH resources if the slot or the subslot in which the PUCCH is transmitted includes at least one SBFD symbol. Otherwise, the UE may determine a PUCCH resource from the first list of PUCCH resources. In some implementations, the UE may determine a PUCCH resource from the first list of PUCCH resources, and if the PUCCH resource is included in the SBFD symbols and is not within the UL subband or if the PUCCH resource is included in both the SBFD and non-SBFD symbols, the UE may determine another PUCCH resource from the second list of PUCCH resources.

For determining the PUCCH resource for the CSI report transmission, the following (a) may be applied.

(a) An SR configuration may be associated with one or more SR resource configurations. An SR resource configuration may configure a PUCCH resource which is one of the PUCCH resources configured by one of the two PUCCH resource configurations, and the one of the two PUCCH resource configurations may be the PUCCH resource configuration for the SBFD symbols or the PUCCH resource configuration for the non-SBFD symbols. In other words, an SR resource configuration may be associated with the PUCCH resource configuration for the non-SBFD symbols or the PUCCH resource configuration for the SBFD symbols. The association may be explicitly indicated in the SR resource configuration. In some implementations, the MAC entity of the UE may select a PUCCH resource configured by an SR resource configuration associated with the PUCCH resource configuration for the SBFD symbols for the SR transmission when the PUCCH resource configured by the SR resource configuration is included within the SBFD symbols and within the UL subband or when the PUCCH resource is included within the non-SBFD symbols. The MAC entity of the UE may select a PUCCH resource configured by an SR resource configuration associated with the PUCCH resource configuration for the non-SBFD symbols for the SR transmission when the PUCCH resource configured by the SR resource configuration is included within the non-SBFD symbols.

For UCI multiplexing of overlapping PUCCH resources, the following (a) or (b) may be applied.

(a) A UCI multiplexing procedure may be performed over PUCCH resources configured via either the PUCCH resource configuration for the non-SBFD symbols or the PUCCH resource configuration for the non-SBFD symbols. In other words, in the UCI multiplexing procedure, the set of PUCCH resources (e.g., the PUCCH resource set Q) may include only PUCCH resources configured via the PUCCH resource configuration for the non-SBFD symbols or include only the PUCCH resources configured via the PUCCH resource configuration for the SBFD symbols. Up to two UCI multiplexing procedures may be performed for a slot or a subslot, one may be for the PUCCH resources configured via the PUCCH resource configuration for the non-SBFD symbols and another may be for the PUCCH resources configured via the PUCCH resource configuration for the SBFD symbols. If a resulting PUCCH resource is included within the SBFD symbols and not within the UL subband or if the resulting PUCCH resource is included within both the non-SBFD symbols and SBFD symbols, the resulting PUCCH resource may be dropped. In some implementations, the PUCCH resources included in the PUCCH resource set Q may include a PUCCH resource that may be dropped based on the above method. For example, a PUCCH resource for the CSI report included within both the non-SBFD symbols and the SBFD symbols may be included in the PUCCH resource set Q. In some implementations, the PUCCH resources that may be dropped based on the above method may not be included in the PUCCH resource set Q.

(b) A UCI multiplexing procedure may be performed over the PUCCH resources configured via the PUCCH resource configuration for the non-SBFD symbols and the PUCCH resource configuration for the non-SBFD symbols. In other words, in the UCI multiplexing procedure, the set of PUCCH resources (e.g., the PUCCH resource set Q) may include the PUCCH resources configured via the PUCCH resource configuration for the non-SBFD symbols and the PUCCH resources configured via the PUCCH resource configuration for the SBFD symbols. A UCI multiplexing procedure may be performed for a slot or a subslot. When a PUCCH resource is to be selected (e.g., a candidate PUCCH resource) from a group of overlapping PUCCH resources in step 2 as described above, the candidate PUCCH resource may be within the UL subband if the PUCCH resource is included within the SBFD symbols. In some implementations, the PUCCH resource may be within either the non-SBFD symbols or the SBFD symbols. In some implementations, if the group of overlapping PUCCH resources includes a HARQ-ACK PUCCH resource which is within both the non-SBFD symbols or the SBFD symbols, a new PUCCH resource set for selecting a PUCCH resource for the HARQ-ACK and other UCI may be determined from the PUCCH resource configuration for the SBFD symbols.

When a configured UL transmission within an UL subband is colliding with a configured DL reception within a DL subband, the configured DL reception may be dropped if both the configured UL transmission and the configured DL reception are based on the parameters for the SBFD symbols. When a configured UL transmission within an UL subband is colliding with a configured DL reception within a DL subband, the configured UL transmission or DL reception based on the parameters for the non-SBFD symbols may be dropped if one of the configured UL transmission or DL reception is based on the parameters for the non-SBFD symbols.

When a configured UL transmission within an UL subband is a repetition (including the initial transmission) of a set of configured UL transmission, which collides with a configured DL reception within a DL subband which is a repetition (including the initial transmission) of a set of configured DL transmission, the configured DL reception may be dropped. The configured DL reception may also be without repetitions. When a configured DL reception for the measurement of the CSI-RS resource within a DL subband is colliding with a configured UL transmission within an UL subband, the configured UL transmission may be dropped. In some implementations, the configured DL reception for the measurement of the CSI-RS resource may be prioritized only if the CSI-ReportConfig associated with the CSI-RS resource includes the report quantity of the SSB index, the CRI, the RSRP, or the SINR.

The definition of collision of the UL transmission and the DL reception may be that at least one SBFD symbol includes both the UL transmission and the DL reception. In some implementations, the definition of collision of the UL transmission and the DL reception may be that a DL-to-UL switching duration preceding the UL transmission overlaps with the DL reception. In some implementations, the definition of collision of the UL transmission and the DL reception may be that a duration of timing advance and a DL-to-UL switching duration preceding the UL transmission overlaps with the DL reception.

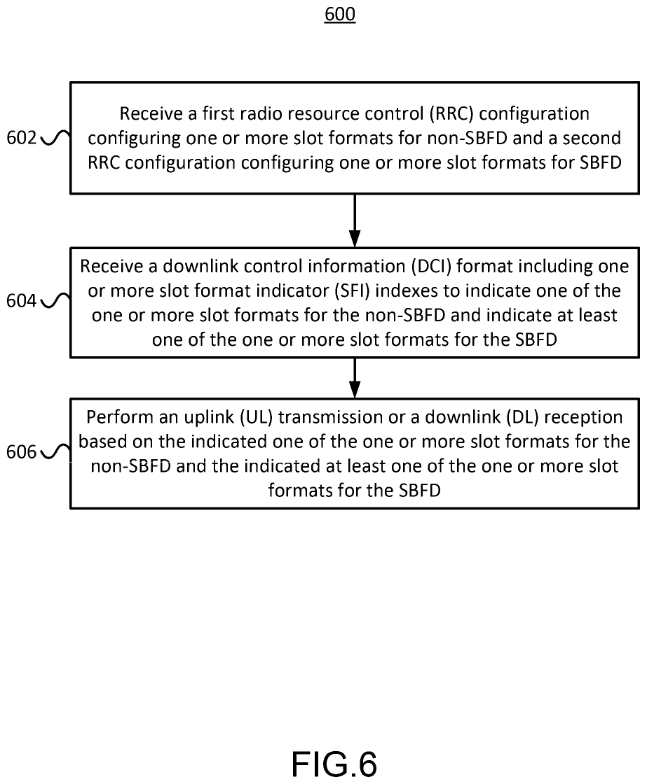

FIG. 6 is a flowchart 600 illustrating a method performed by a UE for an SBFD operation, according to an example implementation of the present disclosure.

In action 602, the UE may receive a first radio resource control (RRC) configuration configuring one or more slot formats for non-SBFD and a second RRC configuration configuring one or more slot formats for SBFD. In some implementations, a first slot format of the one or more slot formats for the SBFD may correspond to a first subband, and a second slot format of the one or more slot formats for the SBFD may correspond to a second subband.

In action 604, the UE may receive a downlink control information (DCI) format including one or more slot format indicator (SFI) indexes to indicate one of the one or more slot formats for the non-SBFD and indicate at least one of the one or more slot formats for the SBFD.

In action 606, the UE may perform an uplink (UL) transmission or a downlink (DL) reception based on the indicated one of the one or more slot formats for the non-SBFD and the indicated at least one of the one or more slot formats for the SBFD. In some implementations, the DL reception may include a physical downlink control channel (PDCCH) reception, a physical downlink shared channel (PDSCH) reception, or a DL reference signal reception. In some implementations, the UL transmission may include a physical uplink control channel (PUCCH) transmission, a physical uplink shared channel (PUSCH) transmission, or a sounding reference signal (SRS) transmission.

In some implementations, in a case that the UL transmission includes the PUCCH transmission and the PUCCH transmission is performed in non-SBFD symbols indicated by the indicated one of the one or more slot formats for the non-SBFD, the PUCCH transmission may be associated with a first PUCCH configuration, and in a case that the UL transmission includes the PUCCH transmission and the PUCCH transmission is performed in SBFD symbols indicated by the indicated at least one of the one or more slot formats for the SBFD, the PUCCH transmission may be associated with a second PUCCH configuration.

In some implementations, in a case that the UL transmission includes the PUCCH transmission and the PUCCH transmission is performed in both the SBFD symbols and the non-SBFD symbols, the PUCCH transmission may be associated with the second PUCCH configuration.

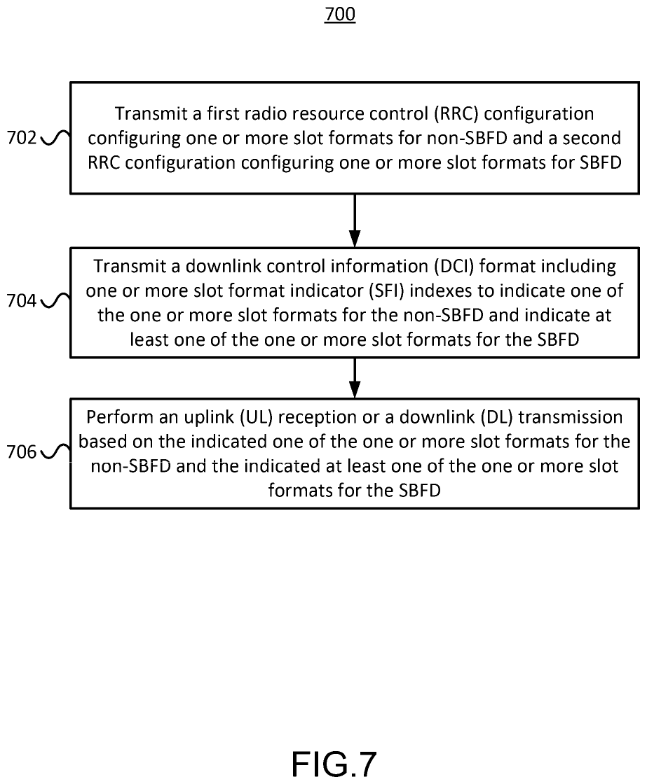

FIG. 7 is a flowchart 700 illustrating a method performed by a BS for an SBFD operation, according to an example implementation of the present disclosure.

In action 702, the BS may transmit a first radio resource control (RRC) configuration configuring one or more slot formats for non-SBFD and a second RRC configuration configuring one or more slot formats for SBFD. In some implementations, a first slot format of the one or more slot formats for the SBFD may correspond to a first subband, and a second slot format of the one or more slot formats for the SBFD may correspond to a second subband.

In action 704, the BS may transmit a downlink control information (DCI) format including one or more SFI indexes to indicate one of the one or more slot formats for the non-SBFD and indicate at least one of the one or more slot formats for the SBFD.

In action 706, the BS may perform an uplink (UL) reception or a downlink (DL) transmission based on the indicated one of the one or more slot formats for the non-SBFD and the indicated at least one of the one or more slot formats for the SBFD. In some implementations, the DL transmission may include a physical downlink control channel (PDCCH) transmission, a physical downlink shared channel (PDSCH) transmission, or a DL reference signal transmission. In some implementations, the UL reception may include a physical uplink control channel (PUCCH) reception, a physical uplink shared channel (PUSCH) reception, or a sounding reference signal (SRS) reception.

In some implementations, in a case that the UL reception includes the PUCCH reception and the PUCCH reception is performed in non-SBFD symbols indicated by the indicated one of the one or more slot formats for the non-SBFD, the PUCCH reception may be associated with a first PUCCH configuration, and in a case that the UL reception includes the PUCCH reception and the PUCCH reception is performed in SBFD symbols indicated by the indicated at least one of the one or more slot formats for the SBFD, the PUCCH reception may be associated with a second PUCCH configuration.

In some implementations, in a case that the UL reception includes the PUCCH reception and the PUCCH reception is performed in both the SBFD symbols and the non-SBFD symbols, the PUCCH reception may be associated with the second PUCCH configuration.

The technical problem addressed by the present disclosure how to dynamically select appropriate slot formats for SBFD and non-SBFD operations to optimize uplink and downlink transmissions. The advantageous technical effect is the enhancement of network flexibility and efficiency, enabling the UE to adapt to different transmission scenarios by selecting suitable slot formats based on the networks configuration, thus improving communication reliability and bandwidth utilization.

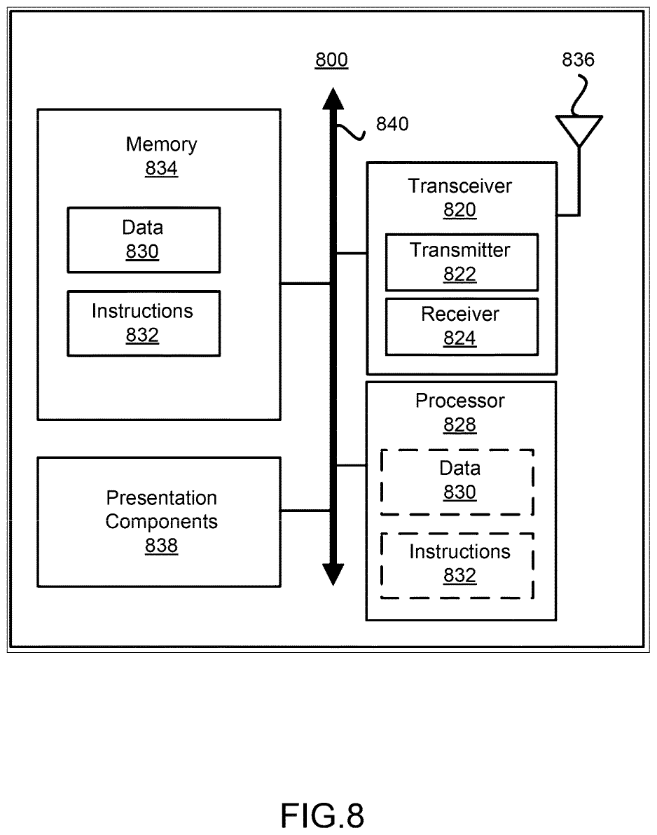

FIG. 8 is a block diagram illustrating a node 800 for wireless communication in accordance with various aspects of the present disclosure. As illustrated in FIG. 8, a node 800 may include a transceiver 820, a processor 828, a memory 834, one or more presentation components 838, and at least one antenna 836. The node 800 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 840. The node 800 may be a UE or a BS that performs various functions disclosed with reference to FIGS. 6 and 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including, but not limited to, usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable instructions 832 (e.g., software codes) that are configured to, when executed, cause the processor 828 to perform various functions disclosed herein, for example, with reference to FIGS. 6 and 7. Alternatively, the instructions 832 may not be directly executable by the processor 328 but may be configured to cause the node 300 (e.g., when compiled and executed) to perform various functions disclosed herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 834, and information transmitted and received via the transceiver 820, the baseband communications module, and/or the network communications module. The processor 828 may also process information to send to the transceiver 820 for transmission via the antenna 836 to the network communications module for transmission to a CN.

One or more presentation components 838 may present data indications to a person or another device. Examples of presentation components 838 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A user equipment (UE) for a subband non-overlapping full duplex (SBFD) operation, the UE comprising:
at least one processor; and
at least one non-transitory computer-readable medium coupled to the at least one processor and storing one or more computer-executable instructions that, when executed by the at least one processor, cause the UE to:
receive a first radio resource control (RRC) configuration configuring one or more slot formats for non-SBFD;
receive a second RRC configuration configuring one or more slot formats for SBFD;
receive a downlink control information (DCI) format including one or more slot format indicator (SFI) indexes that indicate one of the one or more slot formats for non-SBFD and that indicate at least one of the one or more slot formats for SBFD; and
perform an uplink (UL) transmission or a downlink (DL) reception based on the indicated one of the one or more slot formats for non-SBFD and the indicated at least one of the one or more slot formats for SBFD.

2. The UE of claim 1, wherein the DL reception includes one of a physical downlink control channel (PDCCH) reception, a physical downlink shared channel (PDSCH) reception, or a DL reference signal reception.

3. The UE of claim 1, wherein the UL transmission includes one of a physical uplink control channel (PUCCH) transmission, a physical uplink shared channel (PUSCH) transmission, or a sounding reference signal (SRS) transmission.

4. The UE of claim 3, wherein:
in a case that the UL transmission includes the PUCCH transmission and the PUCCH transmission is performed on non-SBFD symbols associated with the indicated one of the one or more slot formats for non-SBFD, the PUCCH transmission is associated with a first PUCCH configuration, and
in a case that the UL transmission includes the PUCCH transmission and the PUCCH transmission is performed on SBFD symbols associated with the indicated at least one of the one or more slot formats for SBFD, the PUCCH transmission is associated with a second PUCCH configuration.

5. The UE of claim 4, wherein in a case that the UL transmission includes the PUCCH transmission and the PUCCH transmission is performed on both the SBFD symbols and the non-SBFD symbols, the PUCCH transmission is associated with the second PUCCH configuration.

6. The UE of claim 1, wherein:
a first slot format of the one or more slot formats for SBFD corresponds to a first subband, and
a second slot format of the one or more slot formats for SBFD corresponds to a second subband.

7. A method performed by a user equipment (UE) for a subband non-overlapping full duplex (SBFD) operation, the method comprising:
receiving a first radio resource control (RRC) configuration configuring one or more slot formats for non-SBFD;
receiving a second RRC configuration configuring one or more slot formats for SBFD;
receiving a downlink control information (DCI) format including one or more slot format indicator (SFI) indexes that indicate one of the one or more slot formats for non-SBFD and that indicate at least one of the one or more slot formats for SBFD; and
performing an uplink (UL) transmission or a downlink (DL) reception based on the indicated one of the one or more slot formats for non-SBFD and the indicated at least one of the one or more slot formats for SBFD.

8-12. (canceled)

13. A base station (BS) for a subband non-overlapping full duplex (SBFD) operation, the BS comprising:
at least one processor; and
at least one non-transitory computer-readable medium coupled to the at least one processor, and storing one or more computer-executable instructions that, when executed by the at least one processor, cause the BS to:
transmit a first radio resource control (RRC) configuration configuring one or more slot formats for non-SBFD;
transmit a second RRC configuration configuring one or more slot formats for SBFD;
transmit a downlink control information (DCI) format including one or more slot format indicator (SFI) indexes that indicate one of the one or more slot formats for non-SBFD and that indicate at least one of the one or more slot formats for SBFD; and
perform an uplink (UL) reception or a downlink (DL) transmission based on the indicated one of the one or more slot formats for non-SBFD and the indicated at least one of the one or more slot formats for SBFD.

14. The BS of claim 13, wherein the DL transmission includes one of a physical downlink control channel (PDCCH) transmission, a physical downlink shared channel (PDSCH) transmission, or a DL reference signal transmission.

15. The BS of claim 13, wherein the UL reception includes one of a physical uplink control channel (PUCCH) reception, a physical uplink shared channel (PUSCH) reception, or a sounding reference signal (SRS) reception.

16. The BS of claim 15, wherein:
in a case that the UL reception includes the PUCCH reception and the PUCCH reception is performed on non-SBFD symbols associated with the indicated one of the one or more slot formats for non-SBFD, the PUCCH reception is associated with a first PUCCH configuration, and
in a case that the UL reception includes the PUCCH reception and the PUCCH reception is performed on SBFD symbols associated with the indicated at least one of the one or more slot formats for SBFD, the PUCCH reception is associated with a second PUCCH configuration.

17. The BS of claim 16, wherein in a case that the UL reception includes the PUCCH reception and the PUCCH reception is performed on both the SBFD symbols and the non-SBFD symbols, the PUCCH reception is associated with the second PUCCH configuration.

18. The BS of claim 13, wherein:
a first slot format of the one or more slot formats for SBFD corresponds to a first subband, and
a second slot format of the one or more slot formats for SBFD corresponds to a second subband.
